(19) United States
(12) Patent Application Publication
(10) Pub. No.: US 2020/0001173 A1
(43) Pub. Date: Jan. 2, 2020

(54) METHOD AND APPARATUS FOR DRIVING AN APPLICATION

(71) Applicant: LG ELECTRONICS INC., Seoul (KR)

(72) Inventors: Junyoung JUNG, Seoul (KR); Hyunkyu KIM, Seoul (KR); Kibong SONG, Seoul (KR); Chulhee LEE, Seoul (KR); Sangkyeong JEONG, Seoul (KR)

(73) Assignee: LG ELECTRONICS INC., Seoul (KR)

(21) Appl. No.: 16/557,960

(22) Filed: Aug. 30, 2019

(30) Foreign Application Priority Data
Aug. 19, 2019 (KR) 10-2019-0101418

(51) Int. Cl. A63F 13/217; G06K 9/00; G05D 1/00; G06T 19/00

(52) U.S. Cl. CPC A63F 13/217; G06K 9/00671; G06N 3/08; G06T 19/006; G05D 1/0088

(57) ABSTRACT

Disclosed are a method and an apparatus of driving an application. The application driving method comprises identifying an executing extended reality application, identifying information on an actual space available for a user of the extended reality application inside a vehicle, controlling information on an interaction space of the extended reality application based on the identified information on the actual space, and driving the extended reality application based on a movement of the user obtained from the controlled interaction space, wherein the interaction space may be a space in which the user's movement is reflected on the extended reality application when the user uses the extended reality application inside the vehicle. At least one of an autonomous vehicle and an interaction space control apparatus of the present invention may be connected to an artificial intelligence module, a drone (Unmanned Aerial Vehicle, UAV), a robot, an augmented reality (AR) device, a virtual reality (VR) device, a device related to 5G service, and so on.

### CROSS-REFERENCE TO RELATED APPLICATION

Pursuant to 35 U.S.C. § 119(a), this application claims the benefit of earlier filing date and right of priority to Korean Patent Application No. 10-2019-0101418, filed on Aug. 19, 2019, the contents of which are hereby incorporated by reference herein in its entirety.

### BACKGROUND OF THE INVENTION

### Field of the Invention

The present disclosure relates to a method of driving an application on an operating apparatus. More specifically, the present disclosure relates to a technique of controlling information on an interaction space based on information on an actual space available for a user inside a vehicle.

### Related Art

When a user uses an application using extended reality (e.g., a virtual reality application, an augmented reality application, a mixed reality application), the virtual space within the application and the actual space may be related. If a user executes such an application in a limited space, restrictions due to space may occur. For example, when an extended reality application is used in a limited space such as a vehicle, a collision with an object inside the vehicle may occur, and thus the actual space available for the user may be limited according to the position of the user in the autonomous vehicle. Therefore, there is a need for a technology that allows the user to use the application while ensuring user safety in such a space.

### SUMMARY OF THE INVENTION

Embodiments disclosed herein disclose a technique of controlling an interaction space of an application corresponding to an actual space available for a user when using the application utilizing extended reality in a limited space such as a vehicle interior. The objective of the present embodiment is not limited to the above-mentioned, and other objectives can be deduced from the following embodiments.

An application operating method according to an embodiment of the present invention may comprise: identifying an executing extended reality application; identifying information on an actual space available for a user of the extended reality application inside a vehicle; determining information on an interaction space of the extended reality application based on the identified information on the actual space; obtaining input information based on a movement of the user; and displaying an output screen related to the extended reality application based on the information on the interaction space and the movement of the user.

An application operating apparatus according to another embodiment of the present invention may comprise: a memory including at least one executable extended reality application; and a processor configured to identify an executing extended reality application, identify information on an actual space available for a user of the extended reality application inside a vehicle, determine information on an interaction space of the extended reality application based on the identified information on the actual space; obtain input information based on a movement of the user; and display an output screen related to the extended reality application based on the information on the interaction space and the movement of the user.

Specific details of other embodiments are included in the detailed description and the drawings.

According to the embodiments of the present disclosure, one or more of the following advantageous effects are obtained.

First, the safety of the user may be guaranteed by controlling the interaction space corresponding to the actual space available for the user inside the autonomous vehicle.

Second, by detecting the movement of the user based on the driving information of the autonomous vehicle to control the interaction space according to the change of the actual space available for the user, the user safety is guaranteed.

Third, by controlling the interaction space according to at least one of the presence or absence of other user inside the autonomous vehicle and whether the other user uses the extended reality application, the user safety is guaranteed.

Fourth, the user can safely use the application by changing the sensitivity of the extended reality application or the content provided by the extended reality application according to the controlled interaction space.

The advantageous effects of the invention are not limited to the above-mentioned, and other advantageous effects which are not mentioned can be clearly understood by those skilled in the art from the claims.

### BRIEF DESCRIPTION OF THE DRAWINGS

FIG. 1 shows an artificial intelligence (AI) device according to an embodiment of the present invention.

FIG. 2 shows an AI server according to an embodiment of the present invention.

FIG. 3 shows an AI system according to an embodiment of the present invention.

FIG. 4 illustrates an actual space by a seat inside a vehicle according to an embodiment of the present invention.

FIG. 5 illustrates a user using an extended reality application according to an embodiment of the present invention.

FIG. 6 illustrates a user movement in accordance with a driving situation of a vehicle according to an embodiment of the present invention.

FIG. 7A illustrates a case where a user rides alone in a vehicle according to an embodiment of the present invention. FIG. 7B illustrates a case where a user and another user who is not using an extended reality application ride together in a vehicle according to an embodiment of the present invention. FIG. 7C illustrates a case where a user and another user both of who are using an extended reality application ride together in a vehicle according to an embodiment of the present invention.

FIG. 8 illustrates a change in sensitivity to input data in accordance with a controlled interaction space according to an embodiment of the present invention.

FIG. 9 illustrates a change in content in an extended reality application in accordance with a controlled interaction space according to an embodiment of the present invention.

FIG. 10A illustrates a reduction in a space for providing content in an extended reality application according to an embodiment of the present disclosure. FIG. 10B illustrates an expansion of a space for providing content in an extended reality application according to an embodiment of the present invention.

FIG. 11 illustrates that available extended reality applications are limited according to an embodiment of the present invention.

FIG. 12 is a flowchart illustrating an interaction space control method according to an embodiment of the present invention.

FIG. 13 is a block diagram of an interaction space control apparatus according to an embodiment of the present invention.

### DESCRIPTION OF EXEMPLARY EMBODIMENTS

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

In addition, in this disclosure, extended reality collectively refers to virtual reality (VR), augmented reality (AR), and mixed reality (MR). VR technology provides real world objects or backgrounds only in CG images, AR technology provides virtually produced CG images on real objects images, and MR technology is a computer graphic technology that mixes and combines virtual objects in the real world and provides them.

MR technology is similar to AR technology in that it shows both real and virtual objects. However, there is a difference in that the virtual object is used as a complementary form to the real object in AR technology while the virtual object and the real object are used in the same nature in the MR technology.

XR technology can be applied to a HMD (Head-Mount Display), a HUD (Head-Up Display), a mobile phone, a tablet PC, a laptop, a desktop, a TV, a digital signage, etc., and a device to which XR technology is applied may be referred to as an XR device.

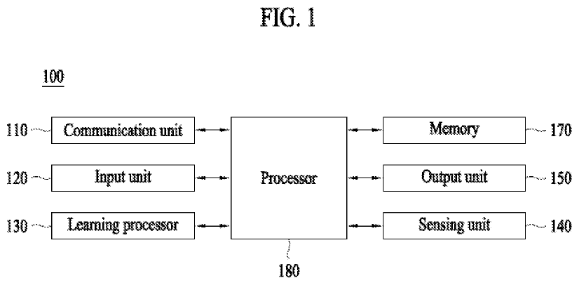

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

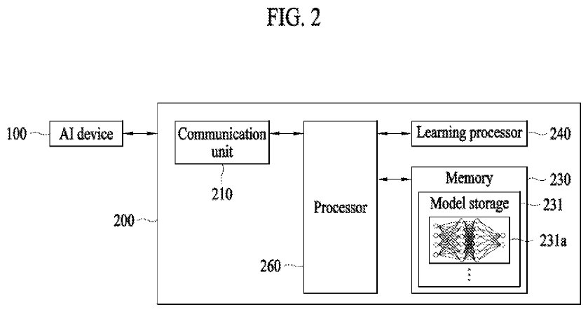

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

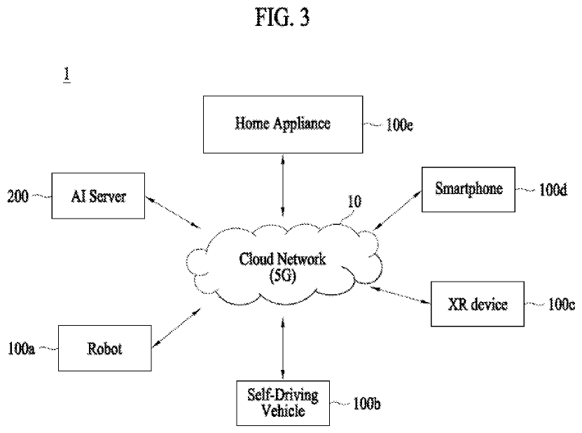

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

In addition, in the present disclosure, XR device 100c is applied with AI technology and implemented as a head-mount display (HMD), a head-up display (HUD) provided in a vehicle, a television, a mobile phone, a smartphone, a computer, a wearable device, and a home appliance. a digital signage, a vehicle, a fixed robot or a mobile robot.

XR device 100c may analyze three-dimensional point cloud data or image data obtained through various sensors or from an external device to generate location data and attribute data for three-dimensional points, thereby acquiring information on the surrounding space or reality object, rendering an XR object to output, and outputting it. For example, XR device 100c may output an XR object including additional information on the recognized object in correspondence with the recognized object.

XR device 100c may perform the above-described operations using a learning model composed of at least one artificial neural network. For example, XR device 100c may recognize a reality object in three-dimensional point cloud data or image data using the learning model, and may provide information corresponding to the recognized reality object. Here, the learning model may be learned directly at XR device 100c or learned from an external device such as AI server 200.

At this time, XR device 100c may perform an operation by generating a result using a learning model by itself, but may transmit sensor information to an external device such as AI server 200 and receive the result generated accordingly to perform an operation.

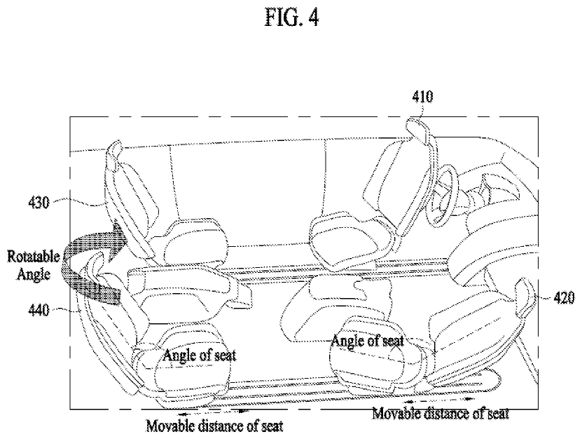

FIG. 4 illustrates an actual space by a seat inside a vehicle according to an embodiment of the present invention.

A vehicle may include at least one seat in a preset position. For example, the vehicle may include a seat 1 410, a seat 2 420, a seat 3 430, and a seat 4 440 in preset positions. At this time, the preset positions where the seats are located may be measured and stored in advance.

The seat inside the vehicle may move from the preset position. At this time, the movable distance from the preset position may be different for each seat. For example, seat 1 410 may move 10 cm back and forth from the preset position, seat 2 420 may move 7 cm back and forth from the preset position, seat 3 430 may move 5 cm back and forth from the preset position, and seat 4 440 may move 6 cm back and forth from the preset position. In addition, the movable distance of each seat may be controlled in consideration of the physical characteristics of the user sitting on the seat. At this time, the control of the movable distance may be determined in consideration of the actual space available for the user according to the user's physical characteristics. For example, when the limbs of the user sitting on seat 1 410 are long, the movable distance of seat 1 410 can be controlled to 5 cm in consideration of the user's physical characteristics and the actual space available for the user according to the movement of the seat.

In addition, the seat inside the vehicle can be tilted according to the angle of the seat. At this time, the angle of the seat may be different for each seat. For example, the angle of seat 1 410 may be 60 to 150 degrees in consideration of the steering wheel, or the angle of seat 3 430 may be 30 to 120 degrees in consideration of seat 1 410. At this time, the actual space available for the user sitting on the seat may be different according to the angle of the seat.

In addition, the seat inside the vehicle can rotate according to the rotatable angle. At this time, the rotatable angle may be different for each seat. For example, the rotatable angle of seat 1 410 may be 180 to 360 degrees in consideration of the left side door, or the rotatable angle of seat 2 420 may be 0 to 180 degrees in consideration of the right side door. At this time, the actual space available for the user sitting on the seat may be different according to the rotatable angle of the seat.

The actual space available for the user may be determined based on at least one of the position of the seat in the vehicle, the angle of the seat, and the rotatable angle. At this time, the actual space determined based on at least one of the position of the seat, the angle of the seat, and the rotatable angle may be stored in the memory. For example, if seat 1 410 is moved 5 cm backwards and the seat angle is 120 degrees and the rotatable angle is 0 degrees, the actual space available for the user sitting on seat 1 410 may be determined based on the position of the seat, the angle of the seat, and the rotatable angle. At this time, the actual space available for the user based on the position, the angle of the seat, and the rotatable angle of seat 1 410 may be identified from the memory.

Here, the actual space available for the user may be a safe space where the user using the application does not collide with an object inside the vehicle. For example, the actual space available for the user may be a space where the user moving the controller does not collide with objects (e.g., steering wheel, side glass, windshield, etc.) in the vehicle. In addition, the interaction space is a space where the user's movement is reflected on the application when the user uses the extended reality application, and may be determined based on a positional relationship between the user and an object inside the vehicle. For example, if a user uses an extended reality application such as an AR application or a VR application using a head mounted display (HMD) and a controller, the interaction space may be the space where the user's action by the controller that the user is moving is reflected on the extended reality application. That is, the interaction space may be a space where the user's movement is reflected on the extended reality application. A specific example of the interaction space in which the user's movement is reflected will be described later.

At this time, the interaction space may be the same as or different from the actual space available for the user. In particular, the interaction space may be the space excluding a margin space from the actual space available for the user. The margin space may be a space for reflecting at least one of user safety and application characteristics. Therefore, the actual space available for the user in the absence of margin space may be the same as the interaction space, or the actual space available for the user in the presence of margin space may be different from the interaction space. In the embodiment, the operating apparatus that executes the application may determine the interaction space so that the user does not come into contact with other objects in the actual space with a margin of a certain distance from other objects. This margin allows the user to perform augmented reality applications without touching other objects, even if the user moves beyond the interaction space.

In addition, in the embodiment, the interaction space may be adjusted based on the driving state of the vehicle. As an example, when the vehicle is driving on a rocky route, the operating apparatus may determine a margin with other objects to be larger when determining the interaction space.

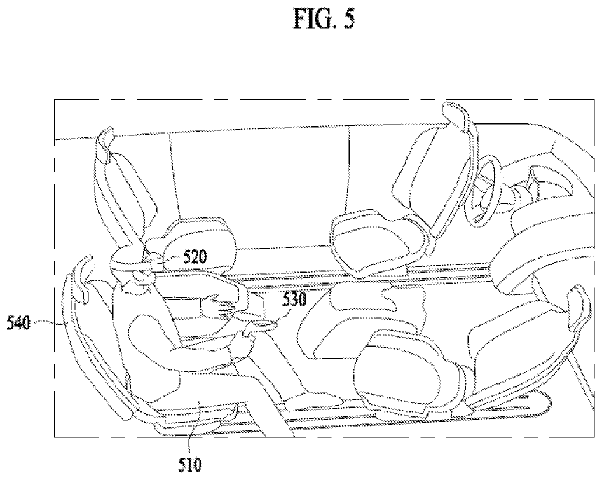

FIG. 5 illustrates a user using an extended reality application according to an embodiment of the present invention.

A user 510 may sit on a seat 540 in a vehicle. At this time, the preset position of seat 540, whether it is moved back and forth from the position, the angle of the seat, and the rotatable angle can be identified. The actual space available for user 510 sitting on seat 540 may be determined based on the identified information.

User 510 may use an extended reality application utilizing a head mounted display (HMD) 520 and a controller 530. Here, the extended reality application may include a virtual reality application, an augmented reality application, and a mixed reality application. Here, the virtual reality application is an application that provides only a CG image of an object or a background of the real world, the augmented reality application is an application that provides a virtual CG image created on the real object image together, and mixed reality application is an application that mixes and combines virtual objects in the real world and provides them.

User 510 may view the extended real world using HMD 520, and user 510 may control the movement of the character in the extended real world using the controller. At this time, the interaction space corresponding to the actual space available for user 510 may be controlled, and the movement of the character in the application space may be determined according to the movement of user 510 in the interaction space. For example, when the actual space available for user 510 is relatively wide, the interaction space corresponding to the actual space may also be controlled to be relatively wide, and the character movement in the application space can be determined according to the movement of user 510 in the wide interaction space. Alternatively, when the actual space available for user 510 is relatively narrow, the interaction space corresponding to the actual space may also controlled to be relatively narrow, and the character movement in the application space can be determined according to the movement of user 510 in the narrow interaction space. At this time, the information related to the extended reality application may change according to the size of the interaction space, which will be described later.

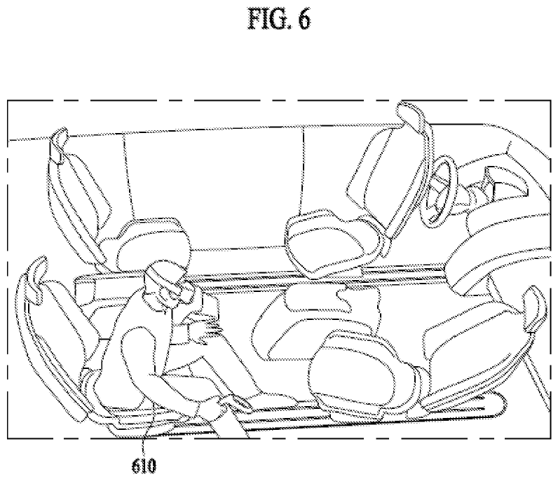

FIG. 6 illustrates a user movement in accordance with a driving situation of a vehicle according to an embodiment of the present invention.

A movement of a user 610 in a vehicle may be changed according to a driving situation of the vehicle (e.g., rapid acceleration and deceleration). For example, when the vehicle stops suddenly, the body of user 610 in the vehicle may be inclined forward. A sensor (e.g., a camera) installed inside the vehicle may detect a change in the movement of user 610 according to the driving situation of the vehicle. The application driving apparatus receiving the change in the user's movement from the sensor may detect a change in the actual space in response to the change in the movement of user 610, and the interaction space may be controlled in response to the degree of change in the actual space.

Due to the movement of user 610 sitting on the seat, the actual space available for the user and the corresponding interaction space may change. For example, when the body of user 610 is inclined forward, the sensor installed in the vehicle may detect the distance between the inclined user 610 and the object in front (e.g., steering wheel, windshield, etc.) that may collide with the user. As the distance between user 610 and the object in front that may collide with the user decreases, the actual space available for the user may be narrower than before, and the interaction space corresponding to the actual space may also be relatively narrow. At this time, the information related to the extended reality application may change according to the change of the interaction space. In another example, when the body of user 610 is tilted to the left, the sensor installed in the vehicle may detect the distance between user 610 tilted to the left and the object on the left (e.g., the left window) that may collide with the user. As the distance between user 610 and the object on the left that may collide with the user decreases, the actual space available for the user may become narrower than before, and the interaction space corresponding to the actual space may also be controlled. At this time, the information related to the extended reality application may change according to the change of the interaction space.

In addition, the interaction space may be controlled in advance based on the driving situation of the vehicle, or a change in the interaction space may be provided to the user in advance. For example, when the user's movement is predicted based on the driving situation of the vehicle, the interaction space may be controlled based on the predicted movement. Alternatively, a change in the interaction space may be provided to the user in advance.

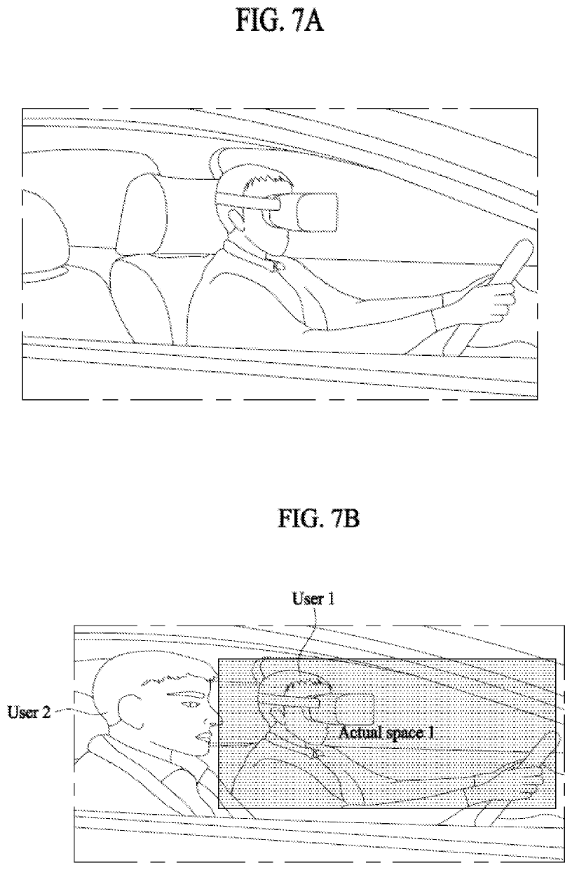

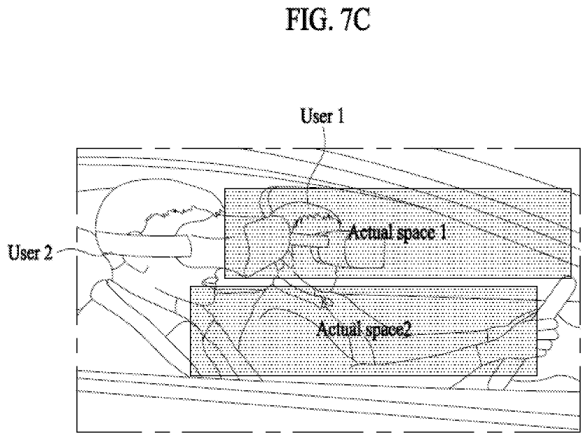

FIG. 7A illustrates a case where a user rides alone in a vehicle according to an embodiment of the present invention. A sensor (e.g., a camera) installed inside the vehicle may detect whether the user rides alone in the vehicle. If the sensor detects that the user using an extended reality application utilizing a HMD and a controller rides in the vehicle alone, the actual space available for the user is not only the space corresponding to the seat the user is sitting on, but also the space corresponding to a seat next to the user. Accordingly, the interaction space corresponding to the actual space can also be controlled relatively widely. Alternatively, if the sensor detects that two users are in the vehicle but one user is in the front seat and the other user is in the back seat, the actual space available for each user in the front and back seats is not only a space corresponding to the seat each user is sitting on, but it may also include a space corresponding to the seat next to each user. Accordingly, the interaction space corresponding to the actual space can also be controlled relatively widely.

FIG. 7B illustrates a case where a user and another user who is not using an extended reality application ride together in a vehicle according to an embodiment of the present invention. A sensor (e.g., a camera) installed inside the vehicle may detect whether a user 1 and a user 2 ride together in the vehicle. When the sensor detects that the user 1 and the user 2 ride together in the vehicle, it is possible that the user 1 uses an extended reality application utilizing a HMD and a controller while the user 2 does not use the extended reality application. At this time, the actual space available for the user 1 using the extended reality application is not only the space corresponding to the seat the user 1 is sitting on, but it may also include the space corresponding to a seat next to the user 2. Specifically, since the user 2 does not use the extended reality application, the space between the user 2 and the object in front (e.g., windshield) that may collide with the users may be included in the actual space available for the user 1 using the extended reality application. Accordingly, the interaction space corresponding to the actual space 1 can also be controlled relatively widely.

FIG. 7C illustrates a case where a user and another user both of who are using an extended reality application ride together in a vehicle according to an embodiment of the present invention. A sensor (e.g., a camera) installed inside the vehicle may detect whether a user 1 and a user 2 ride together in the vehicle. When the sensor detects that the user 1 and the user 2 ride together in the vehicle, it is possible that the user 1 uses an extended reality application utilizing a HMD and a controller and the user 2 also use the extended reality application utilizing a HMD and a controller. At this time, due to the user 1 and the user 2 both of who are using the extended reality application, the actual space 1 available for the user 1 and the actual space 2 available for the user 2 may be distinguished from each other.

At this time, the actual space 1 and the actual space 2 may be spaces corresponding to the seats, which are stored in the memory. Alternatively, they may be determined in consideration of the physical characteristics of the user 1 and the user 2 who are boarding. Specifically, the sensor may detect the physical characteristics (e.g., body and arm lengths) of the user 1 and the user 2 on the seats, and reflect the body characteristics of the user 1 and the user 2 to determine the actual space 1 available for the user 1 and the actual space 2 available for the user 2, respectively. For example, the sensor can detect the arm lengths of the user 1 and the user 2 on the seats, and the actual space 1 available for the user 1 with longer arm length may be wider than the actual space available for the user 2 with relatively short arm length. Alternatively, when the user 1 is an adult and the user 2 is a young child, the actual space 1 available for the user 1 as an adult may be wider than the actual space 2 available for the user 2 as a young child.

An interaction space 1 corresponding to the actual space 1 available for the user 1 and an interaction space 2 corresponding to the actual space 2 available for the user 2 may be set. At this time, the interaction space 1 and the interaction space 2 may be set not to overlap each other for the safety of the user 1 and the user 2. If the user 1 and the user 2 use the same extended reality application, the interaction space 1 and the interaction space 2 corresponding to the user 1 and the user 2, respectively, may be controlled together. Alternatively, when the user 1 and the user 2 use different extended reality applications, the interaction space 1 and the interaction space 2 may be respectively controlled through information exchange.

In addition, when the user 1 leaves the interaction space 1, the controller may notify the user 1 through an alarm (e.g., vibration, noise, etc.). Or, when the user 1 leaves the interaction space 1, the extended reality application used by the user 1 may notify the user 1 by not reflecting the movement of the user 1 outside the interaction space 1. For example, when the user 1 leaves the interaction space 1 and invades the interaction space 2, the controller may notify the user 1 of danger through vibration. Alternatively, when the user 1 leaves the interaction space 1 and invades the interaction space 2, the extended reality application used by the user 1 may notify the user 1 by not reflecting the movement of the user 1 in the interaction space 2.

If the user 1 and the user 2 use the same application, the interaction spaces may be equally controlled based on the driving situation of the vehicle. Alternatively, when the user 1 and the user 2 use different applications, the interaction spaces may be controlled by exchanging information about the actual space 1 and the actual space 2 between the application driving apparatuses of respective users.

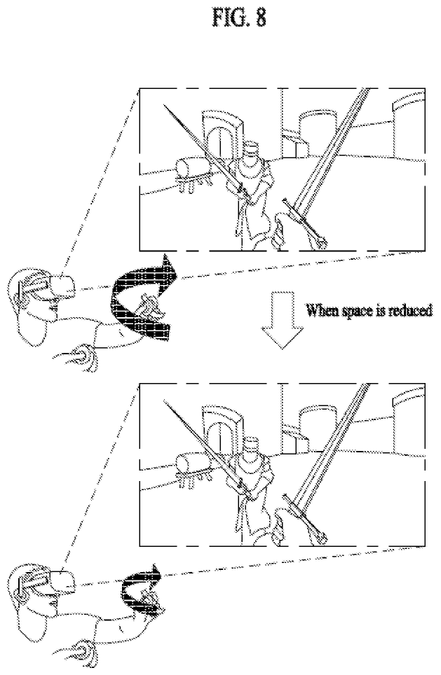

FIG. 8 illustrates a change in sensitivity to input data in accordance with a controlled interaction space according to an embodiment of the present invention.

An extended reality application used by a user sitting on a seat of a vehicle may change a sensitivity to input information according to a controlled interaction space. Here, the input information may include a movement of the user who uses a controller in the interaction space. That is, the movement of the user may be transmitted as the input information of the extended reality application through the controller, and the character in the extended reality application may perform an operation corresponding to the input information. For example, in a martial arts application, when the user extends his/her left hand forward in the interaction space using the controller, the character in the extended reality application may extend his/her left hand forward.

When the actual space available for the user using the extended reality application is reduced and the interaction space corresponding to the actual space is also reduced, the sensitivity corresponding to the input information related to the movement of the user may be increased. At this time, the degree of increase in the sensitivity may be determined in consideration of the degree of change in the interaction space. Specifically, when the user's body is tilted forward due to the sudden stop of the vehicle so that the distance between the user and the steering wheel or the user and the windshield is reduced to reduce the actual space available for the user, the interaction space corresponding to the actual space reduces accordingly. Therefore, when the user needs to use the extended reality application in a relatively narrow space, sensitivity to the input information increases so that the movement of the character in the extended reality application may be reflected to be relatively larger than the actual movement of the user. At this time, the degree of increase in sensitivity may be determined based on at least one of the change in the actual space and the change in the interaction space. For example, when the interaction space is reduced due to the sudden stop of the vehicle, the character in the martial arts application can make a left hand stretch even if the user of the martial arts application actually makes a small left hand movement. At this time, the sensitivity may be determined based on at least one of the degree of change in the actual space available for the user and the degree of decrease in the interaction space due to the sudden stop of the vehicle. The sensitivity for determining the degree of movement of the character in the martial arts application to extend the left hand to stretch in response to the user's actual slight movement of the left hand may be determined based on at least one of the degree of change in the actual space and the degree of change in the interaction space.

Also in the embodiment, when the sensitivity of the input information increases according to the change of the actual space, the user may be provided with such information. For example, information indicating that the input sensitivity is increased may be displayed on a display related to augmented reality of the user. Also in the embodiment, when there is a change in the interaction space according to the change in the actual space, the user may be provided with information on the changed interaction space for the convenience of the user using the application. For example, when the interaction space is reduced, it can be displayed together that a certain area in the existing interaction space of the application would be changed to a new interaction space instead of immediately displaying the information on only the reduced portion. For example, in order to display the change in the interaction space, at least one of a box-shaped icon indicating a certain portion and a color change may be used to display the change in the interaction space. By displaying the information on the interaction space to be changed with the existing interaction space information first and displaying the changed interaction space later, usability of the user may be improved.

When the actual space available for the user using the extended reality application increases and the interaction space corresponding to the actual space also increases, the sensitivity to the input information related to the movement of the user may decrease. At this time, the degree of decrease in the sensitivity may be determined based on at least one of the degree of change in the actual space and the degree of change in the interaction space. Specifically, when the user's body is tilted backward due to the change in the driving state of the vehicle, the distance between the user and the steering wheel or between the user and the windshield increases so that the actual space available for the user increases. Accordingly, the interaction space corresponding to the actual space also increases. Therefore, when the user needs to use the extended reality application in a relatively wide space, the sensitivity to the input information increases so that the movement of the character in the extended reality application may be reflected to be relatively smaller than the actual movement of the user. At this time, the degree of decrease in the sensitivity may be determined based on at least one of the degree of change in the actual space and the degree of change in the interaction space. For example, when the interaction space increases, the character in the martial arts application can extend his/her left hand slightly when the user of the martial arts application actually extends his/her left hand slightly. At this time, the sensitivity that determines the degree to which the character in the martial arts application extends his/her left hand slightly in response to the user's actual slight movement of the left hand may be determined based on at least one of the degree of change in the actual space and the degree of change in the interaction space.

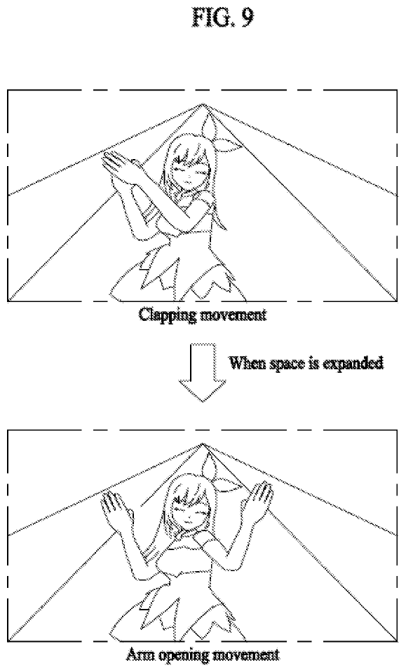

FIG. 9 illustrates a change in content in an extended reality application in accordance with a controlled interaction space according to an embodiment of the present invention.

In the extended reality application used by a user sitting on a seat of a vehicle, the content provided may vary depending on the controlled interaction space.

For example, in the case of an application in which the user follows the movement of the character in the application, when the interaction space increases, the size of the movement of the character in the application may also increase. Specifically, when the interaction space increases, the character in the application may move the arms apart instead of clapping, and the user may follow the movement of the character. At this time, the degree of change in the movement of the character in the application may be determined based on the degree of change in the interaction space. For example, if the interaction space is relatively expanded left and right, the character in the application may open their arms rather than clap, or if the interaction space is relatively expanded back and forth, the character in the application may stretch their arms forward rather than clap. At this time, the change degree of the character's movement may be determined based on the change degree of the interaction space. For another example, in the case of an application in which the user follows the movement of the character in the application, when the interaction space is narrowed, the size of the movement of the character in the application may be also reduced. Specifically, when the interaction space is narrowed, the character in the application may perform a clapping movement instead of an arm opening movement, and the user may follow the movement of the character. Similarly, the degree of change in the movement of the character in the application may be determined based on the degree of change in the interaction space.

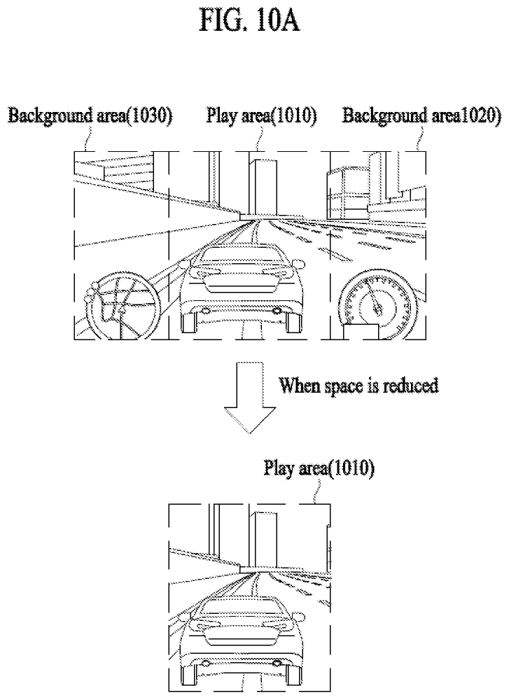

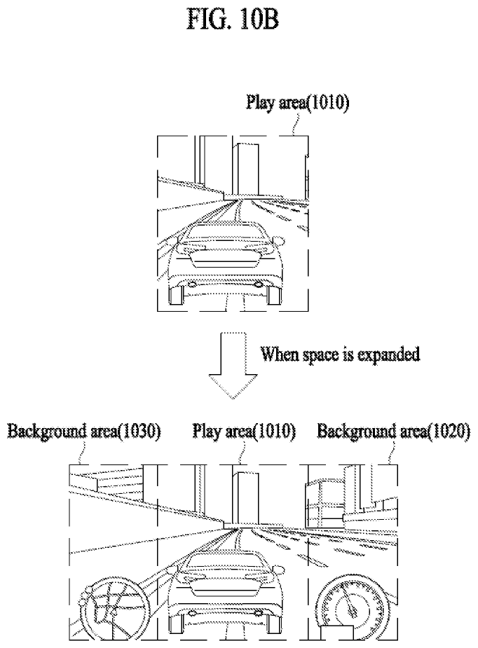

FIG. 10A illustrates a reduction of a space for providing content in an extended reality application according to an embodiment of the present disclosure. FIG. 10B illustrates an expansion of a space for providing content in an extended reality application according to an embodiment of the present invention.

The virtual space in the extended reality application may be a space where content is provided. In addition, the character of the virtual space in the application may perform a movement reflecting the user's movement in the interaction space. For example, if the user moves his/her right hand in the interaction space, the character in the virtual space in the application may also move his/her right hand. At this time, the user's movement may be input information, and the degree of the right hand movement of the character corresponding to the user's right hand movement may be determined according to the sensitivity.

When the actual space available for the user decreases and the interaction space corresponding to the actual space decreases, as shown in FIG. 10A, the virtual space in the extended reality application may also decrease. When the virtual space decreases, the background area may decrease among the play area and the background area. For example, a play area 1010 of the extended reality application is an area where a user plays the application, and background areas 1020 and 1030 are areas related to a background other than play area 1010. That is, background areas 1020 and 1030 instead of play area 1010 may be decreased. At this time, the degree of change in the virtual space may be determined based on at least one of the degrees of changes in the actual space and the interaction space. Specifically, if the left/right change rate of the actual space and/or the interaction space decreases by 10% and 20%, the virtual space may also decrease by 10% and 20%. At this time, as the 10% and 20% of the virtual space decreases, the background area may also decrease by 10% and 20%.

When the actual space available for the user increases and the interaction space corresponding to the actual space increases, as shown in FIG. 10B, the virtual space in the extended reality application may also increase. When the virtual space increases, the background area may increase among the play area and the background area. For example, a play area 1010 of the extended reality application is an area where a user plays the application, and background areas 1020 and 1030 are areas related to a background other than play area 1010. That is, background areas 1020 and 1030 instead of play area 1010 may be increased. At this time, the degree of change in the virtual space may be determined based on at least one of the degrees of changes in the actual space and/or the interaction space. Specifically, if the left/right change rate of the actual space and/or the interaction space increases by 10% and 20%, the virtual space may also increase by 10% and 20%. At this time, as the 10% and 20% of the virtual space increases, the background area may also increase by 10% and 20%.

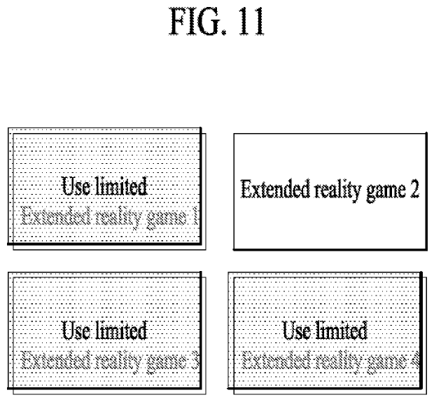

FIG. 11 illustrates that available extended reality applications are limited according to an embodiment of the present invention.

Each extended reality application may require a predetermined space as a preset space. If the interaction space is also narrow because the actual space available for the user is narrow, it may not satisfy the predetermined space, which is a preset space required for use of the extended reality application. At this time, when the interaction space according to the actual space does not satisfy the preset space, the extended reality application may be displayed as an application that is not available for the user. At this time, the predetermined space required for the use of the extended reality application may be a space required for the use of the application within a 360 range around the user. In one example, a wide space between 300 and 60 degrees may be required for application play due to application characteristics.

For example, the actual space available for the user and the interaction space corresponding thereto may not satisfy a predetermined space, which is a preset space required for use of the extended reality application 1. Thus, the use of extended reality application 1 may be limited. Alternatively, the actual space available for the user and the interaction space corresponding thereto may satisfy a predetermined space, which is a preset space required for use of the extended reality application 2. Then, the user can use the extended reality application 2. Alternatively, when the actual space available for the user and the corresponding interaction space are wide in the left and right direction but and relatively narrow in the back and forth direction, the use of the extended reality application 3 may be limited due to the nature of the extended reality application 3 requiring a large space in the back and forth direction. Alternatively, when the actual space available for the user and the corresponding interaction space are wide in the back and forth direction but and relatively narrow in the left and right direction, the use of the extended reality application 4 may be limited due to the nature of the extended reality application 4 requiring a large space in the left and right direction.

In the embodiment, when the interaction space is smaller than a predetermined space, which is a preset space, at least one of the movable distance of the seat, the angle of the seat, or the rotatable angle of the seat may be controlled in consideration of the driving state of the vehicle and the user's movement to adjust the actual space in the vehicle. Therefore, the interaction space of the vehicle may also be changed by adjusting the actual space, and the changed interaction space may be wider than the predetermined space, which is a preset space, so that driving of the application may not be limited.

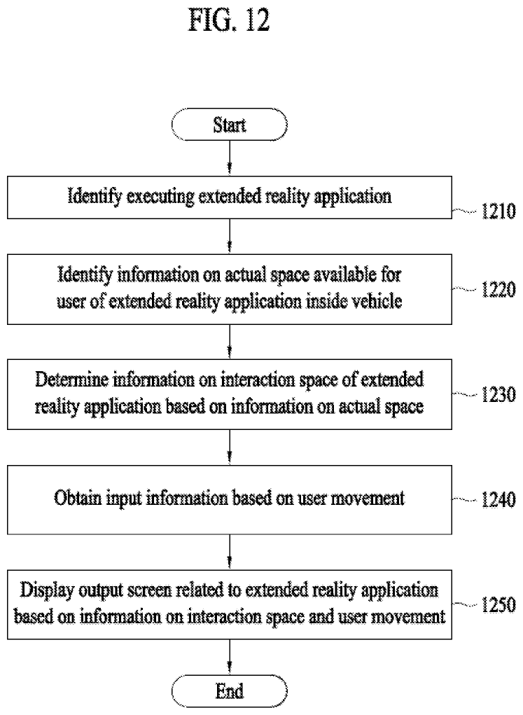

FIG. 12 is a flowchart illustrating an application driving method according to an embodiment of the present invention.

In step 1210, the operating apparatus may identify an extended reality application that is executing. The executing extended reality application may be identified among at least one extended reality application stored in a memory.

In step 1220, information on an actual space available for a user of the extended reality application inside a vehicle may be identified. When the user uses the application at the seat position inside the vehicle, the information on the actual space may be identified based on at least one of the movable distance of the seat, the angle of the seat, and the rotatable angle. Here, the actual space may be a space where the user does not collide with an object inside the vehicle. At this time, the interaction space corresponding to the actual space is a space in which the user's movement is reflected on the extended reality application when the user uses the extended reality application in the vehicle, and may be determined based on a positional relationship between the user and an object inside the vehicle.

The movable distance of the seat is a distance in which the seat may move in back and forth direction and it may be previously measured and stored in the memory. The angle of the seat is a tilt angle of the corresponding seat and it may be previously measured and stored in the memory. The rotatable angle is the angle at which the seat can rotate in position and it may be previously measured and stored in the memory. According to the movable distance of the seat, the angle of the seat, and the rotatable angle, the actual space available for the user on that seat may be measured in advance and stored in the memory. However, when the sensor detects a body characteristic of the user who rides in the vehicle, the actual space available for the user may be controlled based on the detected body characteristic of the user. For example, if it is determined that the arm length of the user is long, the actual space available for the user stored in the memory may be adjusted by estimating the moving range by the long arm of the user.

In addition, the available actual space may be controlled based on the user's movement in the seat position according to the driving situation of the vehicle. At this time, when the movement of the vehicle is predicted based on driving information such as the speed and movement of the vehicle, the movement of the user may be predicted according to the movement of the vehicle, and the available actual space may be controlled based on the movement of the vehicle. For example, when the user is inclined forward due to a sudden change in the speed of the vehicle, the sensor may detect the degree of inclination of the user and the actual space available for the user may be controlled according to the degree of inclination. For another example, when a user's movement according to a user's body characteristics is predicted along a driving path of the vehicle, the state of the seat may be changed so that the available actual space is controlled based on the predicted user's movement.

In addition, the actual space available for the user may be controlled according to whether or not another user is located on another seat in the vehicle. Specifically, the actual space available for the user may be controlled when both the user and the other user board the front seats, unlike when the user and the other user board the front seat and the back seat, respectively. In other words, the actual space available for the user may be reduced due to another user boarding next to the user. Or, if there is another user in a different seat, the available actual space may be controlled depending on whether the other users use the extended reality application or not. Specifically, when the other user does not use the extended reality application, the actual space available for the user may wider than when the other user uses the extended reality application. If both the user and the other user use the extended reality application, the actual space and the interaction space may be controlled so as not to overlap each other.

In addition, the extended reality application that the user can use may be limited based on the interaction space corresponding to the actual space available for the user. Each extended reality application may require a predetermined space, which is a preset space for normal use, and the extended reality application may be restricted to the user when the actual space does not satisfy the predetermined space. For example, when the interaction space is smaller than the predetermined space required for driving the extended reality application, the driving of the extended reality application may be restricted.

If the interaction space is smaller than the preset space, at least one of the movable distance of the seat, the angle of the seat, or the rotatable angle of the seat is controlled in consideration of the driving state of the vehicle and the movement of the user, thereby allowing the interaction space to satisfy a preset space.

In step 1230, the information on the interaction space of the extended reality application may be determined based on the identified information on the actual space. The interaction space may be a space where the movement of the user through the controller is reflected on the application when the user uses the extended reality application.

When the actual space is controlled, the interaction space corresponding to the actual space may also be controlled, and the sensitivity of the extended reality application to the input information may change according to the controlled interaction space. Here, the input information is a user's movement through the controller, and the character in the extended reality application may follow the user's movement, which is the input information. The sensitivity may be a relationship between the movement of the user and the movement of the character. Specifically, when the interaction space is increased, the sensitivity may be decreased, or when the interaction space is decreased, the sensitivity may be increased. For example, if the interaction space is decreased, the sensitivity is increased, so that the character can show a lot of movement even if the user moves only a little. In addition, the information related to the change in sensitivity is displayed so that the user can confirm the related information.

In addition, when the user uses the application inside the vehicle, the interaction space may be determined based on the user's movement according to the driving situation (e.g., rapid acceleration or sudden stop) of the vehicle. In addition, when the user uses the application inside the vehicle, the interaction space may be controlled according to the position of another user on another seat in the vehicle. Specifically, when different users are located on different seats, the respective interaction spaces of the user and the other user may be controlled together if the other user use the same extended reality application as the user, or the respective interaction spaces of the user and the other user may be controlled by exchanging information between the user and the other user if the other user uses a different extended reality application from the one used by the user. In addition, the driving of the extended reality application available for the user may be limited based on the interaction space.

In addition, when the actual space is controlled, the interaction space corresponding to the actual space may be controlled, and the content provided by the extended reality application may be changed according to the controlled interaction space. For example, in the case of an extended reality application in which a user follows a dance movement, the dance movement may be changed from the clapping movement to the arm opening movement if the interaction space is expanded. At this time, the degree of change in content such as the movement of the character may be determined based on the degree of change in the interaction space.

In addition, the virtual space in the extended reality application may include a play area and a background area. The background area may be changed according to the controlled interaction space, and the degree of change in the background area may be determined by the degree of change in the interaction space.

In step 1240, input information based on the user's movement may be obtained. When the user moves through the controller, the user's movements can be reflected on the extended reality application as the input information.

In step 1250, an output screen related to the extended reality application may be displayed based on the information on the interaction space and the user's movement. The user wearing an HMD can see the output screen for the extended reality application reflecting the related information.

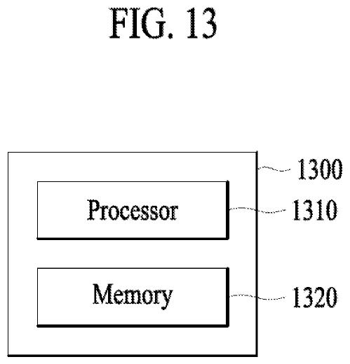

FIG. 13 is a block diagram of an interaction application driving apparatus according to an embodiment of the present invention.

According to an embodiment of the present invention, an application driving apparatus 1300 may include a processor 1310 and a memory 1320. Application driving apparatus 1300 may further include a communication unit (not shown) capable of transmitting and receiving data. It is apparent for those skilled in the art that the features and functions of processor 1310, memory 1320, and the communication unit (not shown) may correspond to processor 180, memory 170, and communication unit 110 of FIG. 1. In addition, memory 1320 may be embedded in the application driving apparatus 1300 or may be installed externally, and when installed outside, application driving apparatus 1300 may receive information stored in memory 1320. Processor 1310 may typically control the overall operation of application driving apparatus 1300. For example, processor 1310 may control the communication unit, the sensor, and the like in general by executing programs stored in memory 1320.

In addition, processor 1310 may identify the actual space available for the user at the seat position based on the physical characteristics of the user in the vehicle. At this time, the actual space available for the user may be identified by reflecting the physical characteristics of the user. In addition, processor 1310 may control the interaction space corresponding to the actual space to be applied to the extended reality application used by the user at the seat position. Here, the interaction space may be a space where the movement of the user is reflected on the application when the user uses the extended reality application. In addition, processor 1310 may control the sensitivity of the input information to the extended reality application or control the content provided by the extended reality application to correspond to the controlled interaction space.

Although the exemplary embodiments of the present invention have been described in this specification with reference to the accompanying drawings and specific terms have been used, those are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

What is claimed is:

1. A method of driving an application on an operating apparatus, the method comprising:
identifying an executing extended reality application;
identifying information on an actual space available for a user of the extended reality application inside a vehicle;
determining information on an interaction space of the extended reality application based on the identified information on the actual space;
obtaining input information based on a movement of the user; and
displaying an output screen related to the extended reality application based on the information on the interaction space and the movement of the user.

2. The method of claim 1, wherein, when the user is located on a seat inside the vehicle, the information on the actual space is identified based on at least one of a movable distance of the seat, an angle of the seat, and a rotatable angle of the seat.

3. The method of claim 2, wherein the interaction space is a space where the movement of the user is reflected on the extended reality application when the user uses the extended reality application inside the vehicle and is determined in consideration of a positional relationship between an object inside the vehicle and the user according to the movement of the user that is changed according to a driving state of the vehicle.

4. The method of claim 2, wherein, if there is another user inside the vehicle, the interaction space is controlled in further consideration of a positional relationship with the other user not to overlap the interaction space of the other user.

5. The method of claim 4, wherein the interaction space is controlled, if there is the other user inside the vehicle,
when the other user uses the same extended reality application as the user, the respective interaction spaces of the user and the other user are controlled together, and
when the other user uses a different extended reality application from the user, the respective interaction spaces of the user and the other user are controlled through information exchange.

6. The method of claim 1, wherein sensitivity corresponding to the input information is determined in response to a change in the interaction space, so that the sensitivity decreases when the interaction space increases or the sensitivity increases when the interaction space decreases, and
a degree of change in the sensitivity is determined based on a degree of change in the interaction space.

7. The method of claim 6, further comprising displaying information related to the change of the sensitivity.

8. The method of claim 1, wherein a movement of a character on the extended reality application corresponding to the user is determined according to the controlled interaction space; and a degree of change of the movement of the character is determined in response to a degree of change in the interaction space.

9. The method of claim 1, wherein a virtual space in the extended reality application includes a play area and a background area,
the background area is changed according to the controlled interaction space,
a degree of change in the background area is determined by a degree of change in the interaction space.

10. The method of claim 1, wherein the actual space inside the vehicle is adjusted by controlling at least one of a movable distance of a seat, an angle of the seat, and a rotatable angle of the seat in consideration of a driving state of the vehicle and the movement of the user when the interaction space is smaller than a preset space.

11. A computer-readable non-volatile storage medium that stores an instruction for executing the method of claim 1 on a computer.

12. An application driving apparatus comprising:
a memory including at least one executable extended reality application; and
a processor configured to identify an executing extended reality application, identify information on an actual space available for a user of the extended reality application inside a vehicle, determine information on an interaction space of the extended reality application based on the identified information on the actual space; obtain input information based on a movement of the user; and display an output screen related to the extended reality application based on the information on the interaction space and the movement of the user.

13. The apparatus of claim 12, wherein, when the user is located on a seat inside the vehicle, the information on the actual space is identified based on at least one of a movable distance of the seat, an angle of the seat, and a rotatable angle of the seat.

14. The apparatus of claim 13, wherein the interaction space is a space where the movement of the user is reflected on the extended reality application when the user uses the extended reality application inside the vehicle and is determined in consideration of a positional relationship between an object inside the vehicle and the user according to the movement of the user that is changed according to a driving state of the vehicle.

15. The apparatus of claim 13, wherein the interaction space is controlled, if there is another user inside the vehicle, in further consideration of a positional relationship with the other user not to overlap the interaction space of the other user.

16. The apparatus of claim 15, wherein the interaction space is controlled, if there is the other user inside the vehicle,
when the other user uses the same extended reality application as the user, the respective interaction spaces of the user and the other user are controlled together, and
when the other user uses a different extended reality application from the user, the respective interaction spaces of the user and the other user are controlled through information exchange.

17. The apparatus of claim 12, wherein sensitivity corresponding to the input information is determined in response to a change in the interaction space, so that the sensitivity decreases when the interaction space increases or the sensitivity increases when the interaction space decreases, and
a degree of change in the sensitivity is determined based on a degree of change in the interaction space.

18. The apparatus of claim 12, wherein a movement of a character on the extended reality application corresponding to the user is determined according to the controlled interaction space; and the degree of change of the movement of the character is determined in response to the degree of change in the interaction space.

19. The apparatus of claim 12, wherein a virtual space in the extended reality application includes a play area and a background area,
the background area is changed according to the controlled interaction space,
a degree of change in the background area is determined by the degree of change in the interaction space.

20. The apparatus of claim 12, wherein the actual space inside the vehicle is adjusted by controlling at least one of a movable distance of a seat, an angle of the seat, or a rotatable angle of the seat in consideration of a driving state of the vehicle and the movement of the user when the interaction space is smaller than a preset space.
